(19) United States
(12) Patent Application Publication
(10) Pub. No.: US 2023/0376960 A1
(43) Pub. Date: Nov. 23, 2023

(54) SYSTEMS AND METHODS FOR GENERATING POSTINGS

(71) Applicant: JPMORGAN CHASE BANK, N.A., New York, NY (US)

(72) Inventors: Vaibhav VYAS, Pleasantville, NY (US); Madhu BANGALORE, Wilmington, DE (US); Lawrence Charles DRAKE, Newark, DE (US); Sanjay NAGPAL, New York, NY (US); Soniya GANDHI, New York, NY (US)

(21) Appl. No.: 17/664,570

(22) Filed: May 23, 2022

(51) Int. Cl. G06Q 20/40; G06Q 40/02

(52) U.S. Cl. CPC G06Q 20/4016; G06Q 40/02

(57) ABSTRACT

A method for generating postings may include a posting generation service (PGS) computer application executed by an electronic device: (1) receiving an instruction from a source system that requires generation and/or processing of account movements; (2) identifying a transaction type for the instruction; (3) retrieving a profile out of a plurality of profiles based on the transaction type, wherein the profile specifies one or more checks to be performed on the instruction; (4) retrieving rules associated with the profile; (5) generating postings for the transaction based the rules; (6) executing, by the PGS computer application, the one or more checks specified by the retrieved profile comprising a sanctions screening check, a fraud check, a fund check, a posting check, and an outgoing financial message check; and (7) generating an acknowledgement for the source system.

### BACKGROUND OF THE INVENTION

### 1. Field of the Invention

Embodiments relate generally to systems and methods for generating transaction-related postings.

### 2. Description of the Related Art

Organizations often have a complex account and entity structure, resulting in multiple accounting entries to affect a cross entity book transfer. Thus, products offered by these entities are dependent on several systems, such as payment systems, to process non-payment transactions.

### SUMMARY OF THE INVENTION

Systems and methods for generating postings are disclosed. In one embodiment, a method may include: (1) receiving, by a posting generation service (PGS) computer application executed by an electronic device, an instruction from a source system that requires generation and/or processing of account movements; (2) identifying, by the PGS computer application, a transaction type for the instruction; (3) retrieving, by the PGS computer application, a profile out of a plurality of profiles based on the transaction type, wherein the profile specifies one or more checks to be performed on the instruction; (4) retrieving, by the PGS computer application, rules associated with the profile; (5) generating, by the PGS computer application, postings for the transaction based the rules; (6) executing, by the PGS computer application, the one or more checks specified by the retrieved profile comprising a sanctions screening check, a fraud check, a fund check, a posting check, and an outgoing financial message check; and (7) generating, by the PGS computer application, an acknowledgement for the source system.

In one embodiment, the source system may include a banking system that leverages the PGS computer application with the instruction.

In one embodiment, the transaction type may identify whether the transaction is an internal transaction or an external transaction, a number of jurisdictions for the transaction, and a number of currencies for the transaction.

In one embodiment, the method may also include enriching, by the PGS computer application, the instruction with reference data that may be received from a reference data service. The reference data may include data regarding a branch, a nostro account, a ledger, and/or client details required to process the transaction.

In one embodiment, the sanctions screening check may check the transaction for specific words identifying a prohibited party, a prohibited jurisdiction, and/or a prohibited account.

In one embodiment, the fraud check may check an account, a branch currency, and maker/checker for fraud based on a fraud rule.

In one embodiment, the fund check may validate that a money movement can happen based on an account position for an account involved in the transaction.

In one embodiment, the posting check may check for postings for the transaction and causes postings to be posted to a physical account.

In one embodiment, the outgoing financial message check may check the transaction for outgoing financial messages and may be configured to cause outgoing financial messages to be sent to the source system.

According to another embodiment, a non-transitory computer readable storage medium may include instructions stored thereon that when read and executed by one or more computers cause the one or more computers to: receive an instruction from a source system that requires generation and/or processing of account movements; identify a transaction type for the instruction; retrieve a profile out of a plurality of profiles based on the transaction type, wherein the profile specifies one or more checks to be performed on the instruction; retrieve rules associated with the profile; generate postings for the transaction based the rules; execute the one or more checks specified by the retrieved profile comprising a sanctions screening check, a fraud check, a fund check, a posting check, and an outgoing financial message check; and generate an acknowledgement for the source system.

In one embodiment, the transaction type may identify whether the transaction is an internal transaction or an external transaction, a number of jurisdictions for the transaction, and a number of currencies for the transaction.

In one embodiment, the non-transitory computer readable storage medium may also include instructions that cause the one or more computers to enrich the instruction with reference data that may be received from a reference data service. The reference data may include data regarding a branch, a nostro account, a ledger, and/or client details required to process the transaction.

In one embodiment, the sanctions screening check may check the transaction for specific words identifying a prohibited party, a prohibited jurisdiction, and/or a prohibited account.

In one embodiment, the fraud check may check an account, a branch currency, and maker/checker for fraud based on a fraud rule.

In one embodiment, the fund check may validate that a money movement can happen based on an account position for an account involved in the transaction.

In one embodiment, the posting check may check for postings for the transaction and causes postings to be posted to a physical account.

In one embodiment, the outgoing financial message check may check the transaction for outgoing financial messages and is configured to cause outgoing financial messages to be sent to the source system.

Embodiments may direct postings to cash accounts and general ledgers, where appropriate.

Embodiments may provide a highly configurable system that meets multiple use cases across global products.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for generating postings according to an embodiment; and

FIG. 2 depicts a method for generating postings according to an embodiment.

### DETAILED DESCRIPTION OF PREFERRED EMBODIMENTS

Embodiments are generally directed to systems and methods for generating postings.

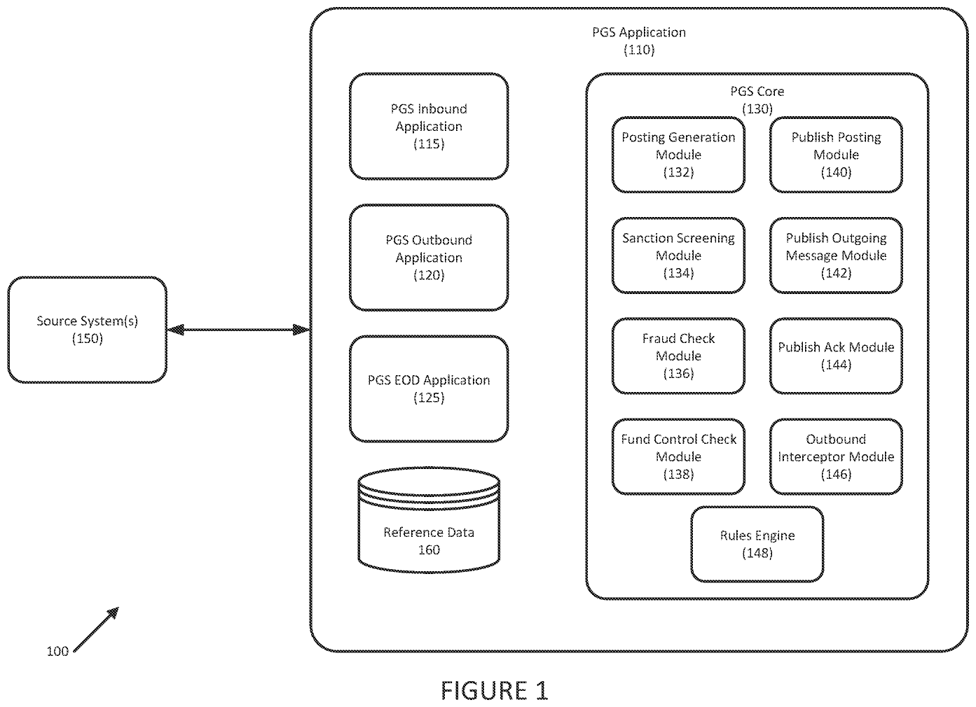

Referring to FIG. 1, a system for generating postings is disclosed according to an embodiment. System 100 may include Posting Generation Service (PGS) Application 110. PGS Application 110 may be a computer program, application, and/or collection of microservices that process financial transactions and makes settlement through direct postings to ledger applications (e.g., for accounts within the same institution) or by the creation of outgoing financial messages (e.g., SWIFT) to the payment processing platform (e.g., for accounts outside of the institution). PGS Application 110 may include applications or microservices, including PGS Inbound Application 115, PGS Outbound Application 120, PGS End of Day (EOD) Application 125, and PGS Core Application 130.

PGS Inbound Application 115 may be a light weight/cut down version of PGS core 130 that exposes REST endpoints for source systems 150 to communicate with PGS Application 110. Instead, or in addition, PGS Inboard Application 115 may provide messaging interfaces, such as MQ and KAFKA interfaces, for the source systems 150 to send instruction requests to PGS Application 110. Thus, PGS Inbound Application 115 may be the access point for source systems 150.

Source systems 150 may include any system that may leverage the functionality of PGS Application 110 by sending an instruction to PGS application 110.

PGS Inbound Application 115 may further delegate work to PGS Core 130 for posting generation.

PGS Outbound Application 120 may control asynchronous interactions with source systems 150. PGS Outbound Application 120 may ensure that PGS core 130 remains light weight as it can focus on its use case of handling instruction received from source system by delegating other asynchronous handling to PGS Outbound Application 120.

PGS EOD Application 125 may process EOD messages and business dates.

PGS Core Application 130 may be based on a “chain of responsibility” pattern. PGS Core Application 130 may be further subdivided into a set of chains/modules, including posting generation module 132, sanction screening module 134, fraud check module 136, fund control check module 138, publish posting module 140, publish outgoing message module 142, publish acknowledgement module 144, outbound interceptor module 146, and/or rules engine 148.

Posting generation module 132 may generate postings for one or more source systems 150. These postings are related to a client or their nostro accounts. In general, postings provide details on how money is to move among different accounts. For example, for a single location profile, the generated postings are only for the client side as there is no nostro account involved.

Sanction screening module 134 may screen transactions for potential sanctions issues. For example, sanction screening module 134 may checks for any specific words that may indicate a sanctions issue (e.g., prohibited parties, jurisdictions, accounts, etc.) in the message. If any specific words are found, the message will be routed for manual review before it may be released.

Fraud check module 136 may check a transaction for potential fraud. For example, fraud check module 136 may check for account, branch currency, maker/checker as per fraud rule and history of those combinations. Fraud check module 136 may generate a warning that may require manual review if the transaction is suspected to be fraudulent.

Fund control check module 138 may verify that sufficient funds are available for the transaction. For example, fund control check module 138 may validate that a certain money movement can happen or not based on a client's account position.

Publish posting module 140 may publish postings generated by posting generation module 132 to one or more source systems 150. Publish posting module 140 may send details to internal systems for transactions within the financial institution.

Publish outgoing message module 142 may publish financial messages, such as SWIFT messages, to one or more source systems 150. The postings may be made to a physical account, such as a demand deposit account (DDA).

Publish acknowledgement module 144 may publish acknowledgements to one or more source systems 150 once the instruction is complete.

Outbound interceptor module 146 may receive notifications from PGS Core 130 to send a feed to a system such as cash management (not shown), reporting systems, etc. The feed may be asynchronous flows.

Rules engine 148 may store and apply rules to the transaction, messages, etc. For example, rules engine 148 may store conditions and corresponding actions associated with the conditions, and may apply the conditions to the transaction.

Reference data 160 may be a separate service that may store data that may be required to complete a transaction, such as branch details, nostro accounts, ledgers, client information, etc. In one embodiment, PGS inbound application 115, PGS outbound application 120, PGS EOD application 125, any of the services in PGS core 130, etc. may invoke this reference data service to pull the data as required. Consumer services (not shown) may pull data from reference data 160 as required.

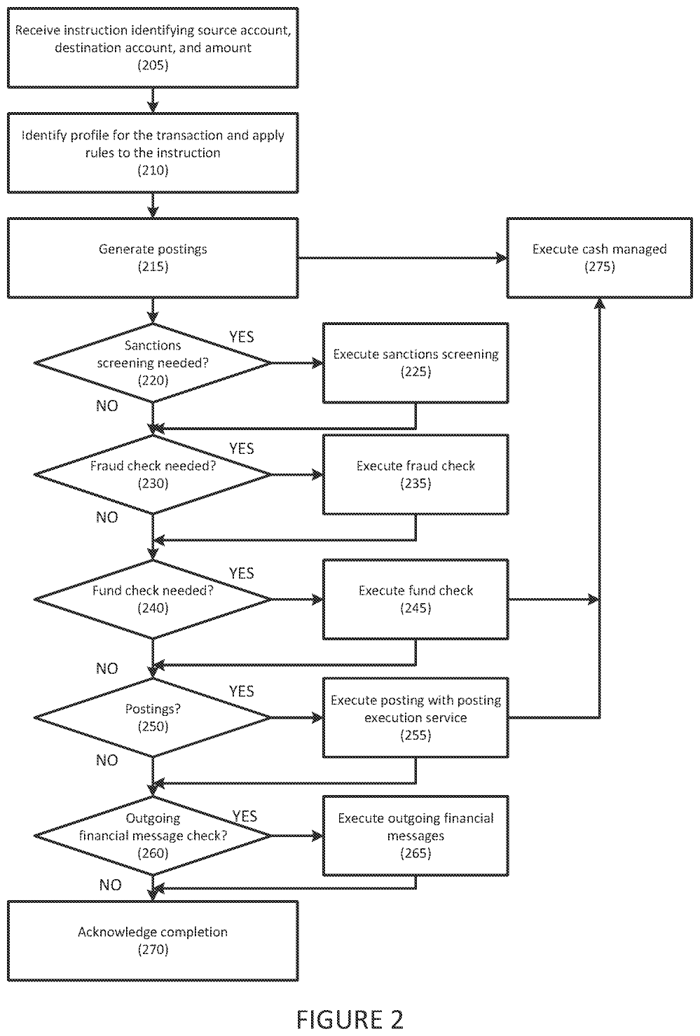

Referring to FIG. 2, a method for generating postings is disclosed according to an embodiment.

In step 205, a PGS application may receive an instruction from a source system, such as an application or service that requires the generation and/or processing of account movements. The source systems may send the instruction to the PGS application over one or more channels, including, for example, MQ, KAFKA, and REST endpoints. The instruction may include, for example, an identification of a source account, an identification of a destination account, an amount, a branch, and any other details necessary and/or desired to process and generate postings.

In step 210, the PGS application may identify a transaction type associated with the instruction and may retrieve a profile for the type of transaction. The transaction may involve an entity outside of the financial institution, may be internal to the financial institution, may involve one or more jurisdictions, may involve one or more currencies, etc. For example, the PGS application may identify the transaction type as ‘Single location Single Currency’ and may then retrieve the profile for that type of transaction. This retrieved profile will govern how many postings are to be generated for this type of transaction. As another example, the PGS application may identify the transaction type as ‘Cross border single currency’, which may signify that the instruction is to generate postings between cross locations. The retrieved profile may then govern the generated postings.

In one embodiment, the PGS application may also enrich the instruction received from the system with reference data that may be received from a reference data service. The reference data may include, for example, data regarding the branch, nostro accounts, ledger, client details, etc. that may be required to process a given transaction. The PGS application may use the enriched data along with the instruction to retrieve rules from a rules engine that identify conditions and corresponding actions associated with the conditions. The rules engine may use the enriched data as an input and may then determine the action. The retrieved profile may govern the postings that need to be generated.

In step 215, the PGS Core Application may generate postings for the instructions based on the rules from the rules engine. The postings may be generated based on the retrieved profile, and may vary based on the retrieved profile. For example, a single location, single currency profile may settle the postings directly between client accounts, while a cross border profile may involve nostro accounts and will have different postings. In generating the postings, the PGS core knows dependencies around sanctions, fraud check, fund control, and other downstream checks.

In one embodiment, the flow depicted may be sequential, so that after each check is performed, the next step governed by the retrieved profile is performed. In embodiments, only the checks specified by the retrieved profile may be performed.

In step 220, a product configuration may determine if sanctions screening is needed. In embodiments, the PGS application may maintain a set of configurations that determine whether sanctions screening is to be invoked for a given flow. If sanctions screening is needed, in step 225, sanctions screening may be executed in any suitable manner.

In step 230, the product configuration may determine if a fraud check is needed. In embodiments, the PGS application may maintain a set of configurations that determine whether a fraud check is to be invoked for a given flow. If a fraud check is needed, in step 235, a fraud check may be executed in any suitable manner.

In step 240, the product configuration may determine if a fund check is needed. In embodiments, the PGS application may maintain a set of configurations that determine whether a fund check is to be invoked for a given flow. If a fund check is needed, in step 245, a fund check may be executed in any suitable manner. After the fund check is completed, the process moves to posting.

In step 250, the selected profile may determine if postings are to be routed to internal ledgers. This is determined based on whether the settled accounts are internal to the financial institution or not. In step 255, the postings are published to posting execution service, which in turn identifies where exactly this posting is to be routed further. Depending on branch and other combinations, postings may be to various internal ledgers.

In step 275, after steps 215, 245, and 255, a feed may be sent to a cash management system that may maintain the cash positions for accounts, such as nostro accounts, so that it can predict how much cash needs to be maintained for settling the transactions that are flowing through the systems.

After the postings check, the process may continue to the next stage (e.g., posting routing) based on the retrieved profile.

In step 260, the selected profile may determine if postings are to be routed externally, such as to SWIFT. This is determined based on whether the settled accounts are internal to the financial institution or not. In step 265, the PGS application may generate the requisite outgoing financial message(s).

In step 270, once the process is complete, the PGS application may return an acknowledgement to the system that provided the instruction. If the process is unsuccessful, then a negative acknowledgement will be sent to the source system.

Although multiple embodiments have been described, it should be recognized that these embodiments are not exclusive to each other, and that features from one embodiment may be used with others.

Hereinafter, general aspects of implementation of the systems and methods of the invention will be described.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of a compact disc, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for generating postings, comprising:
receiving, by a posting generation service (PGS) computer application executed by an electronic device, an instruction from a source system that requires generation and/or processing of account movements;
identifying, by the PGS computer application, a transaction type for the instruction;
retrieving, by the PGS computer application, a profile out of a plurality of profiles based on the transaction type, wherein the profile specifies one or more checks to be performed on the instruction;
retrieving, by the PGS computer application, rules associated with the profile;
generating, by the PGS computer application, postings for the transaction based on the rules;
executing, by the PGS computer application, the one or more checks specified by the retrieved profile comprising a sanctions screening check, a fraud check, a fund check, a posting check, and an outgoing financial message check; and
generating, by the PGS computer application, an acknowledgement for the source system.

2. The method of claim 1, wherein the source system comprises a banking system that leverages the PGS computer application with the instruction.

3. The method of claim 1, wherein the transaction type identifies whether the transaction is an internal transaction or an external transaction, a number of jurisdictions for the transaction, and a number of currencies for the transaction.

4. The method of claim 1, further comprising:
enriching, by the PGS computer application, the instruction with reference data that may be received from a reference data service.

5. The method of claim 4, wherein the reference data comprises data regarding a branch, a nostro account, a ledger, and/or client details required to process the transaction.

6. The method of claim 1, wherein the sanctions screening check checks the transaction for specific words identifying a prohibited party, a prohibited jurisdiction, and/or a prohibited account.

7. The method of claim 1, wherein the fraud check checks an account, a branch currency, and maker/checker for fraud based on a fraud rule.

8. The method of claim 1, wherein the fund check validates that a money movement can happen based on an account position for an account involved in the transaction.

9. The method of claim 1, wherein the posting check checks for postings for the transaction and causes postings to be posted to a physical account.

10. The method of claim 1, wherein the outgoing financial message checks the transaction for outgoing financial messages and is configured to cause outgoing financial messages to be sent to the source system.

11. A non-transitory computer readable storage medium, including instructions stored thereon, which when read and executed by one or more computers cause the one or more computers to perform steps comprising:
receive an instruction from a source system that requires generation and/or processing of account movements;
identify a transaction type for the instruction;
retrieve a profile out of a plurality of profiles based on the transaction type, wherein the profile specifies one or more checks to be performed on the instruction;
retrieve rules associated with the profile;
generate postings for the transaction based the rules;
execute the one or more checks specified by the retrieved profile comprising a sanctions screening check, a fraud check, a fund check, a posting check, and an outgoing financial message check; and
generate an acknowledgement for the source system.

12. The non-transitory computer readable storage medium of claim 11, wherein the transaction type identifies whether the transaction is an internal transaction or an external transaction, a number of jurisdictions for the transaction, and a number of currencies for the transaction.

13. The non-transitory computer readable storage medium of claim 11, further comprising instructions stored thereon, which when read and executed by one or more computers cause the one or more computers to enrich the instruction with reference data that may be received from a reference data service.

14. The non-transitory computer readable storage medium of claim 13, wherein the reference data comprises data regarding a branch, a nostro account, a ledger, and/or client details required to process the transaction.

15. The non-transitory computer readable storage medium of claim 11, wherein the sanctions screening check checks the transaction for specific words identifying a prohibited party, a prohibited jurisdiction, and/or a prohibited account.

16. The non-transitory computer readable storage medium of claim 11, wherein the fraud check checks an account, a branch currency, and maker/checker for fraud based on a fraud rule.

17. The non-transitory computer readable storage medium of claim 11, wherein the fund check validates that a money movement can happen based on an account position for an account involved in the transaction.

18. The non-transitory computer readable storage medium of claim 11, wherein the posting check checks for postings for the transaction and causes postings to be posted to a physical account.

19. The non-transitory computer readable storage medium of claim 11, wherein the outgoing financial message checks the transaction for outgoing financial messages and is configured to cause outgoing financial messages to be sent to the source system.
